(19) United States
(12) Patent Application Publication
(10) Pub. No.: US 2012/0194513 A1
(43) Pub. Date: Aug. 2, 2012

(54) IMAGE PROCESSING APPARATUS AND METHOD WITH THREE-DIMENSIONAL MODEL CREATION CAPABILITY, AND RECORDING MEDIUM

(75) Inventors: Keiichi Sakurai, Tokyo (JP); Mitsuyasu Nakajima, Tokyo (JP); Takashi Yamaya, Tokyo (JP); Yuki Yoshihama, Tokyo (JP)

(73) Assignee: CASIO COMPUTER CO., LTD., Tokyo (JP)

(21) Appl. No.: 13/360,952

(22) Filed: Jan. 30, 2012

(30) Foreign Application Priority Data
Feb. 1, 2011 (JP) 2011-019709

(51) Int. Cl. G06T 15/00

(52) U.S. Cl. 345/419

(57) ABSTRACT

A three-dimensional modeling unit creates a three-dimensional model from a pair of images stored in a keyframe storage in every several frame periods. A feature point detection unit detects feature points in images stored in the keyframe storage. Then, a positional change estimate unit estimates positional change of the detected feature points in a latest image and calculates conversion parameters for converting the created three-dimensional model to a three-dimensional model corresponding to the latest image based on the estimation results. Then, a reconstruction unit reconstructs the created three-dimensional model using the calculated conversion parameters and a image output unit outputs it to a display device on a frame period basis.

### CROSS-REFERENCE TO RELATED APPLICATION

This application claims the benefit of Japanese Patent Application No. 2011-019709, filed on Feb. 1, 2011, the entire disclosure of which is incorporated by reference herein.

### FIELD

This application relates to a technique of creating a three-dimensional model of a subject.

### BACKGROUND

Techniques of creating three-dimensional models from photographic images of a subject captured in different directions are known.

For example, a user is photographed by cameras installed on either side of a monitor screen and the captured images are used to create a three-dimensional model of the user. Then, a three-dimensional image of the user is displayed on the monitor screen based on the three-dimensional model of the user.

Procedures necessary for creating a three-dimensional model include (1) detecting feature points in images, (2) executing stereo-matching on the feature points, and (3) creating a polygon from the matched feature points. It takes much time to create a three-dimensional model; therefore, some delay occurs in displaying a three-dimensional image of a user on a monitor screen.

### SUMMARY

The image processing apparatus according to a first exemplary aspect of the present invention comprises:

an image acquirer which successively acquires sets of images of a subject captured at different positions;

a three-dimensional model creator which creates a three-dimensional model of the subject from one set of images selected among the sets of images successively acquired by the image acquirer;

a feature point detector which detects feature points in the one set of images;

a positional change acquirer which acquires positional change of the feature points detected by the feature point detector in a latest image acquired by the image acquirer;

a conversion parameter calculator which calculates conversion parameters for converting the three-dimensional model created by the three-dimensional model creator to a three-dimensional model corresponding to the latest image based on the positional change of the feature points acquired by the positional change acquirer;

a reconstructor which reconstructs the three-dimensional model created by the three-dimensional model creator based on the conversion parameters;

a render which creates a three-dimensional model in which an image of the subject in the latest image is applied as texture to the three-dimensional model reconstructed by the reconstructor; and

a display controller which causes a display device to display the three-dimensional model created by the rende.

The image processing method according to a second exemplary aspect of the present invention is an image processing method for an image processing apparatus displaying a three-dimensional model on a display device, comprising:

successively acquiring sets of images of a subject captured at different positions;

creating a three-dimensional model of the subject from one set of images selected among the sets of images successively acquired;

detecting feature points in the one set of images;

acquiring positional change of the detected feature points in a latest image among the sets of images successively acquired;

calculating conversion parameters for converting the created three-dimensional model to a three-dimensional model corresponding to the latest image based on the acquired positional change of the feature points;

reconstructing the created three-dimensional model based on the calculated conversion parameters;

creating a three-dimensional model in which an image of the subject in the latest image is applied as texture to the reconstructed three-dimensional model; and

displaying the created three-dimensional model on the display device.

The non-transitory computer-readable recording medium according to a third exemplary aspect of the present invention is a recording medium having stored therein a program executable by a computer that controls an image processing apparatus displaying a three-dimensional model on a display device, causing the computer to realize functions of:

successively acquiring sets of images of a subject captured at different positions;

creating a three-dimensional model of the subject from one set of images selected among the sets of images successively acquired;

detecting feature points in the one set of images;

acquiring positional change of the detected feature points in a latest image among the sets of images successively acquired;

calculating conversion parameters for converting the created three-dimensional model to a three-dimensional model corresponding to the latest image based on the acquired positional change of the feature points;

reconstructing the created three-dimensional model based on the calculated conversion parameters;

creating a three-dimensional model in which an image of the subject in the latest image is applied as texture to the reconstructed three-dimensional model; and

displaying the created three-dimensional model on the display device.

### BRIEF DESCRIPTION OF THE DRAWINGS

A more complete understanding of this application can be obtained when the following detailed description is considered in conjunction with the following drawings, in which:

FIG. 1 is an illustration showing a display system configuration;

FIG. 2 is a block diagram showing a configuration of the image processing apparatus;

FIG. 3 is a flowchart for explaining a modeling procedure;

FIG. 4 is a flowchart for explaining a feature point detection procedure;

FIG. 5 is a flowchart for explaining an orientation change procedure;

FIG. 6 is a flowchart for explaining a display control procedure:

FIGS. 7A to 7I are charts showing chronological change in processing details and data in the image processing apparatus; and

FIGS. 8A and 8B are illustrations showing exemplary screens on which a subject is displayed in multiple modes.

### DETAILED DESCRIPTION

An embodiment of the present invention will be described in detail hereafter with reference to the drawings. The present invention is not confined to the following embodiment and drawings. Furthermore, modifications can be made to the following embodiment and drawings without departing from the scope of the present invention. In the drawings, the same or equivalent components are referred to by the same reference numbers.

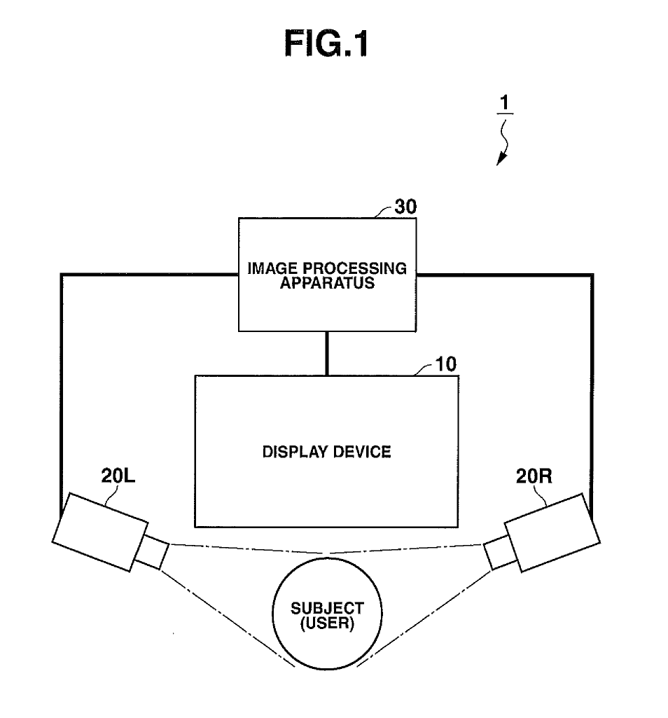

A display system 1 according an embodiment of the present invention will be described. The display system 1 comprises, as shown in FIG. 1, a display device 10, cameras 20L and 20R installed to the left and right of the display device 10, and an image processing apparatus 30. The image processing apparatus 30 is connected to the cameras 20L and 20R and display device 10 via a LAN (local area network) or the like.

The display device 10 is, for example, an LCD (liquid crystal display). The display device 10 is placed with the display screen directly facing a user or a subject. The display device 10 displays images of the user in real time that are (1) captured by the left and right cameras 20L and 20R and (2) processed by the image processing apparatus 30. Since the display device 10 displays the user's own images in real time, the user can use the display device 10 as a minor. Here, the display device 10 can be a display having a three-dimensional display capability.

The cameras 20L and 20R are each provided with a lens, diaphragm mechanism, shutter mechanism, and CCD (charge coupled device) and placed to the left and right of the display device 10, respectively. The cameras 20L and 20R capture images of the user in front of the display device 10 in different directions successively on a predetermined frame period basis (for example, 1/30 second) and transfer the captured image data to the image processing apparatus 30 as needed. The cameras 20L and 20R are in sync and capture images of the user or a subject at the same time.

The cameras 20L and 20R will simply be referred to as the cameras 20 hereafter where they are not distinguished from each other. Furthermore, images captured by the cameras 20L and 20R are referred to as an image L and an image R, respectively, where necessary.

The image processing apparatus 30 is a conventional computer such as a PC (personal computer) and server. The image processing apparatus 30 (1) creates a three-dimensional model of the user from images captured by the cameras 20, (2) creates an image of the user seen in any direction from the created three-dimensional model, and (3) outputs the image to the display device 10. The image processing apparatus 30 is physically composed of a CPU (central processing unit), a ROM (read only memory) storing operation programs, a RAM (random access memory) serving as the work area, a hard drive serving as the memory, and an external interface.

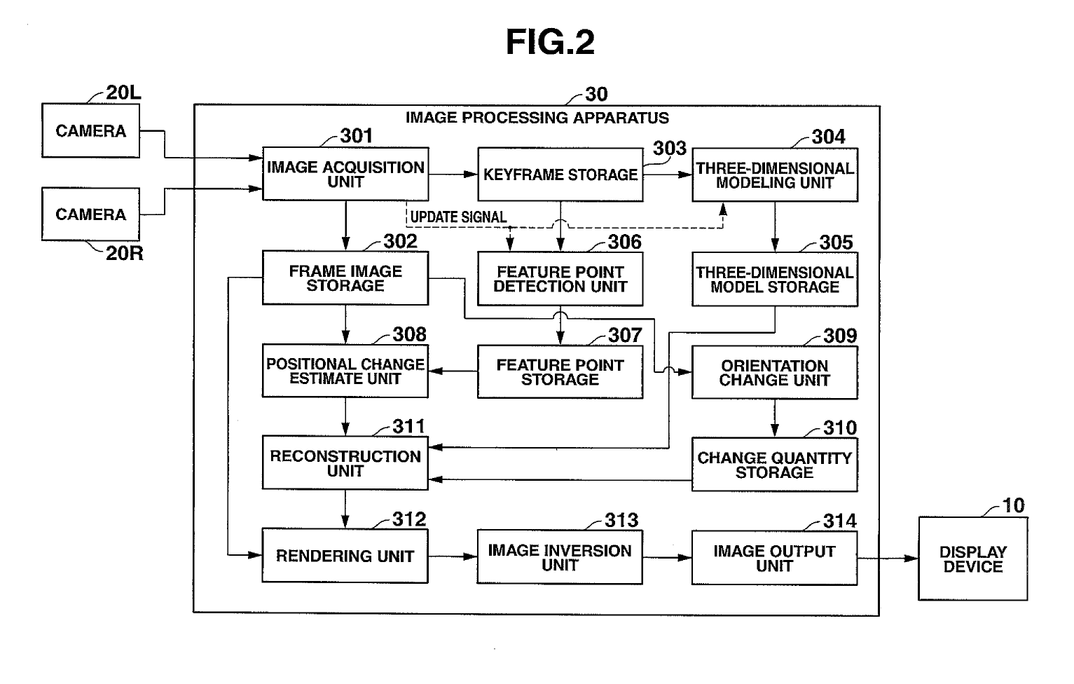

The image processing apparatus 30 is functionally composed of, as shown in FIG. 2, an image acquisition unit 301, a frame image storage 302, a keyframe storage 303, a three-dimensional modeling unit 304, a three-dimensional model storage 305, a feature point detection unit 306, a feature point storage 307, a positional change estimate unit 308, an orientation change unit 309, a change quantity storage 310, a reconstruction unit 311, a rendering unit 312, an image inversion unit 313, and an image output unit 314.

The image acquisition unit 301 receives pairs of images captured by the cameras 20 successively on a frame period basis and stores the received pairs of images in the frame image storage 302 in sequence. The pairs of images stored in the frame image storage 302 are given frame numbers in the order of capture.

Furthermore, the image acquisition unit 301 stores in the keyframe storage 303 a pair of images received from the cameras 20 on a frame period basis (for example, in every eight frame periods) and sends an update signal to the three-dimensional modeling unit 304 and the feature point detection unit 306.

Receiving the update signal from the image processing unit 301, the three-dimensional modeling unit 304 starts to operate, creating a three-dimensional model of the user from the pair of images stored in the keyframe storage 303 and storing it in the three-dimensional model storage 305. Here, the three-dimensional modeling unit 304 possesses attribute information (field angle, reference line length, etc.) of the cameras 20.

Receiving the update signal from the image acquisition unit 301, the feature point detection unit 306 starts to operate, detecting feature points in one of the pair of images (for example, the image L) stored in the keyframe storage 303. Then, the feature point detection unit 306 stores information regarding the detected feature points (the positions of feature points in the image, correlation values around the feature points, etc.) in the feature point storage 307 at the time of reception of the next update signal.

The positional change estimate unit 308 obtains positional change of the feature points detected by the feature point detection unit 306 in a latest image stored in the frame image storage 302 (namely an image received from the cameras 20 most recently) on a frame period basis. Then, the positional change estimate unit 308 obtains conversion parameters for converting the three-dimensional model stored in the three-dimensional model storage 305 to a three-dimensional model corresponding to the latest image based on the obtained change.

The orientation change unit 309 performs an orientation change procedure to acquire a quantity that is specified by the user for changing the orientation of the three-dimensional model and store it in the change quantity storage 310. The orientation change procedure will be described in detail later.

The reconstruction unit 311 reconstructs the three-dimensional model stored in the three-dimensional model storage 305 based on the conversion parameters obtained by the positional change estimate unit 308 and the rotational correction quantity stored in the change quantity storage 310. More specifically, the reconstruction unit 311 rotates or translates the three-dimensional model stored in the three-dimensional model storage 305.

The rendering unit 312 performs 3D rendering in which image data of a latest image among the pairs of images stored in the frame image storage 302 are applied as texture to the three-dimensional model reconstructed by the reconstruction unit 311 to create a final three-dimensional model of the user.

The image inversion unit 313 minor-inverts the three-dimensional model created by the rendering unit 312.

The image output unit 314 outputs and displays the three-dimensional model mirror-inverted by the image inversion unit 313 on the display device 10.

Operation of the image processing apparatus 30 will be described hereafter. First, the procedures performed upon each reception of an update signal from the image acquisition unit 301 will be described.

On a frame period basis (for example, in every eight frame periods), the image acquisition unit 301 stores a pair of images received from the cameras 20L and 20R in the keyframe storage 303 and sends an update signal to the three-dimensional modeling unit 304 and the feature point detection unit 306. In response to reception of the update signal, the three-dimensional modeling unit 304 and the feature point detection unit 306 perform a modeling procedure and a feature point detection procedure, respectively.

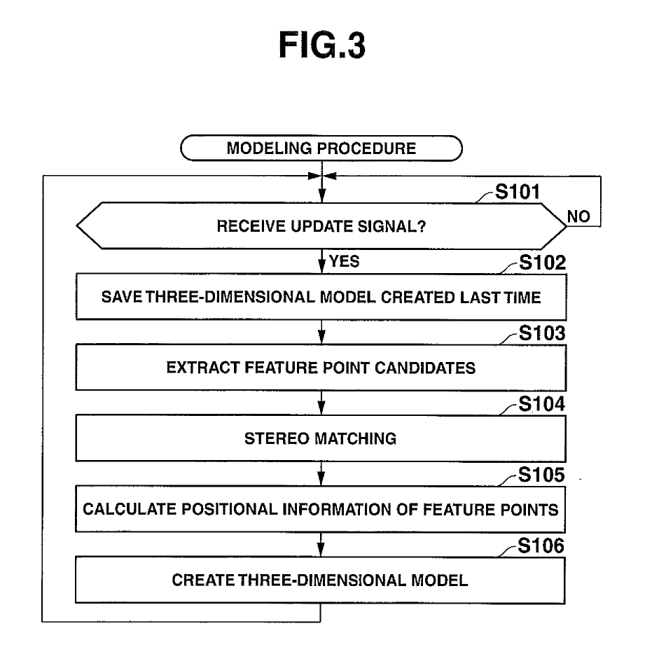

The modeling procedure will be described in detail hereafter with reference to the flowchart of FIG. 3. The modeling procedure is a procedure to create a three-dimensional model of the user (subject) from a pair of images (images L and R) stored in the keyframe storage 303. In other words, the modeling procedure is a procedure to create a three-dimensional model seen in an eye direction.

Receiving an update signal from the image acquisition unit 301 (Step S101; Yes), the three-dimensional modeling unit 304 saves the three-dimensional model created upon reception of the previous update signal in the three-dimensional model storage 305 in an overwrite fashion (Step S102).

Then, the three-dimensional modeling unit 304 extracts feature point candidates from one of the pair of images (for example, the image L) stored in the keyframe storage 303 (Step S103).

For example, the three-dimensional modeling unit 304 detects corners in the image L stored in the keyframe storage 303. For detecting corners, points having a corner feature quantity such as Harris, the corner feature quantity is equal to or greater than a predetermined threshold and largest within a predetermined radius, are selected as corner points. Then, points distinguishable from other points, such as end points, of a subject are extracted as feature points.

Then, the three-dimensional modeling unit 304 performs stereo matching to search the image R for the points corresponding to the feature points in the image L (the corresponding points) (Step S104). More specifically, the three-dimensional modeling unit 304 performs template matching to obtain the points having a similarity level equal to or higher than a predetermined threshold (having a difference level equal to or lower than a predetermined threshold) as the corresponding points. Various known template matching techniques such as sum of absolute differences (SAD), sum of squared differences (SSD), normalized correlation (NCC or ZNCC), and direction sign correlation can be used.

Then, the three-dimensional modeling unit 304 calculates the camera-to-subject distances corresponding to the feature points based on the parallax information of the corresponding points detected in the Step S104 and information indicating the field angles and reference line length of the cameras 20L and 20R, and acquires the position information (x, y, z) of the feature points (Step S105).

Then, the three-dimensional modeling unit 304 performs the Delaunay triangulation based on the acquired position information of feature points to create a polygon and create a three-dimensional model (polygon information) (Step S106). Here, the created three-dimensional model consists of a polygon only with no texture applied thereto. Furthermore, when the next update signal is received (Step S101; Yes), the created three-dimensional model is saved in the three-dimensional model storage 305 (Step S102).

As described above, in the modeling procedure, each time a pair of images is stored in the keyframe storage 303 and an update signal is received, a three-dimensional model of the user is created from the pair of images stored in the keyframe storage 303. Generally, the above modeling procedure (Steps S101 to S106) takes several frame periods of time. Therefore, it is difficult to perform the modeling procedure on the basis of a frame period of the cameras 20 capturing images.

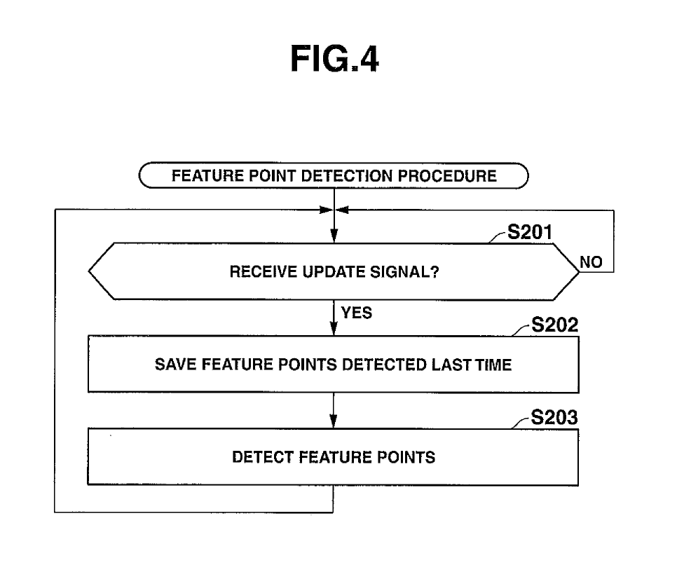

The feature point detection procedure will be described in detail hereafter with reference to the flowchart of FIG. 4. The feature point detection procedure is performed at the same times as the above-described modeling procedure so as to detect and store feature points that are easy to trace from one of the pair of images (the image L in this case) stored in the keyframe storage 303.

Receiving an update signal from the image acquisition unit 301 (Step S201; Yes), the feature point detection unit 306 saves information regarding the feature points detected at the time of reception of the previous update signal (the positions of feature points in the image, correlation values around the feature points, etc.) in the feature point storage 307 (Step S202).

Then, the feature point detection unit 306 detects feature points in the image L stored in the keyframe storage 303 (Step S203). Here, desirably, the feature point detection unit 306 detects as feature points edges or corners that are easy to trace throughout images successively captured. When the next update signal is received (Step S201; Yes), information regarding the detected feature points is saved in the feature point storage 307.

As described above, in the feature point detection procedure, each time a pair of images is stored in the keyframe storage 303 and an update signal is received, feature points are detected in the images stored in the keyframe storage 303 and stored. Generally, the above feature point detection procedure (Steps S201 to S203) takes several frame periods of time. Therefore, it is difficult to perform the feature point detection procedure on the basis of a frame period of the cameras 20 capturing images.

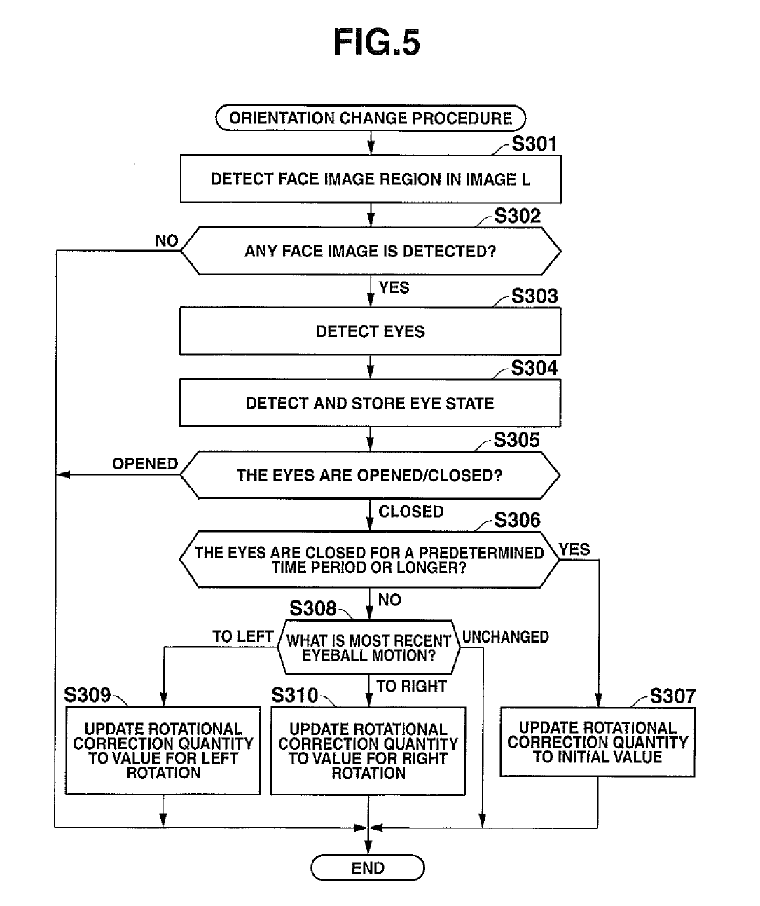

The orientation change procedure will be described in detail hereafter with reference to FIG. 5. The orientation change procedure is a procedure to set a quantity to turn (rotate) the user displayed on the display device 10 (a rotational correction quantity) according to instruction from the user on a predetermined time period basis (for example, in every one second).

As the orientation change procedure starts, first, the orientation change unit 309 analyzes the most recently captured image L among the images stored in the frame image storage 302 and detects a user face region in the image L (Step S301).

For example, the orientation change unit 309 can apply a Sobel filter to the image L so as to extract edges and detect edge regions of which the correlation to a face profile template is greater than a predetermined threshold as a face region.

If no face region is detected (Step S302; No), the orientation change procedure ends without updating the rotational correction quantity.

If a face region is detected (Step S302; Yes), the orientation change unit 309 detects eye images in the face region (Step S303).

For example, the orientation change unit 309 (1) identifies the eyes and surrounding area in the detected face region based on information indicating the average eye position of a human, (2) detects edge lines having a length and curvature appropriate to the eye, and (3) detects the edge lines as the eyes. Here, it is possible to detect only one of the right and left eyes.

Then, the orientation change unit 309 detects the state of the eyes (opened/closed and eyeball position) from the detected eye images, associates information indicating the state with current time information, and accumulates and stores it in the RAM (Step S304).

For example, the orientation change unit 309 binarizes the detected eye images and determines whether a black point of a predetermined size corresponding to an eyeball is detected. The orientation change unit 309 assumes that the eye is opened if a black point is detected and that the eye is closed if no black point is detected. In the case of the eye opened, the orientation change unit 309 further compares the detected black point with the center position of the edge line corresponding to the eye (eyelid) to detect the position of the eyeball (the eye direction).

Then, if the eye state is found to be opened in the Step S304 (Step S305; Opened), the orientation change procedure ends without updating the rotational correction quantity.

On the other hand, if the eye state is found to be closed in the Step S304 (Step S305; Closed), the orientation change unit 309 determines whether the eyes have been closed for a predetermined time period or longer (for example, five seconds) based on the eye state history stored in the RAM (Step S306).

If the eyes have been closed for a predetermined time period or longer (Step S306; Yes), the orientation change unit 309 updates the rotational correction quantity stored in the change quantity storage 310 to an initial value (zero) to orient the user in the original direction (the user is displayed on the display device 10 as he/she is with no orientation change) (Step S307), and the orientation change procedure ends.

If the eyes have not been closed for a predetermined time period or longer (Step S306; No), the orientation change unit 309 determines how the eyeballs have moved in the most recent predetermined time period based on the eye state history stored in the RAM (Step S308).

If the eyeballs are determined to have moved left in the eyes in the most recent predetermined time period (Step S308; to the left), the orientation change unit 309 updates the rotational correction quantity stored in the change quantity storage 310 to a quantity which turn the user face to the left by a predetermined angle (for example, 30 degrees) (Step S309), and the orientation change procedure ends.

On the other hand, if the eyeballs are determined to have moved right in the eyes in the most recent predetermined time period (Step S308; to the right), the orientation change unit 309 updates the rotational correction quantity stored in the change quantity storage 310 to a quantity which turn the user face to the right by a predetermined angle (for example, 30 degrees) (Step S310), and the orientation change procedure ends.

Furthermore, if the eyeballs are determined to be unchanged in position in the most recent predetermined time period (Step S308; Unchanged), the orientation change procedure ends without updating the rotational correction quantity.

As described above, in the orientation change procedure, the user can set a quantity to turn (rotate) the three-dimensional model simply by changing the state of his/her own eyes (opened/closed, eyeball position). The above case employs the following conditions to set a rotational correction quantity:

(1) When the eyes are closed for a predetermined time period or longer, the rotational correction quantity is initialized;

(2) When the eyes are closed and the eye direction is shifted left immediately before the eyes are closed, the rotational correction quantity is updated to a quantity for left rotation; and

(3) When the eyes are closed and the eye direction is shifted right immediately before the eyes are closed, the rotational correction quantity is updated to a quantity for right rotation.

Here, any conditions can be employed to set a rotational correction quantity. For example, it is possible to detect how long the eyes are closed, determine an angle to turn the user to the right (to the left) according to how long the eyes are closed, and set the rotational correction quantity to a quantity indicating the angle.

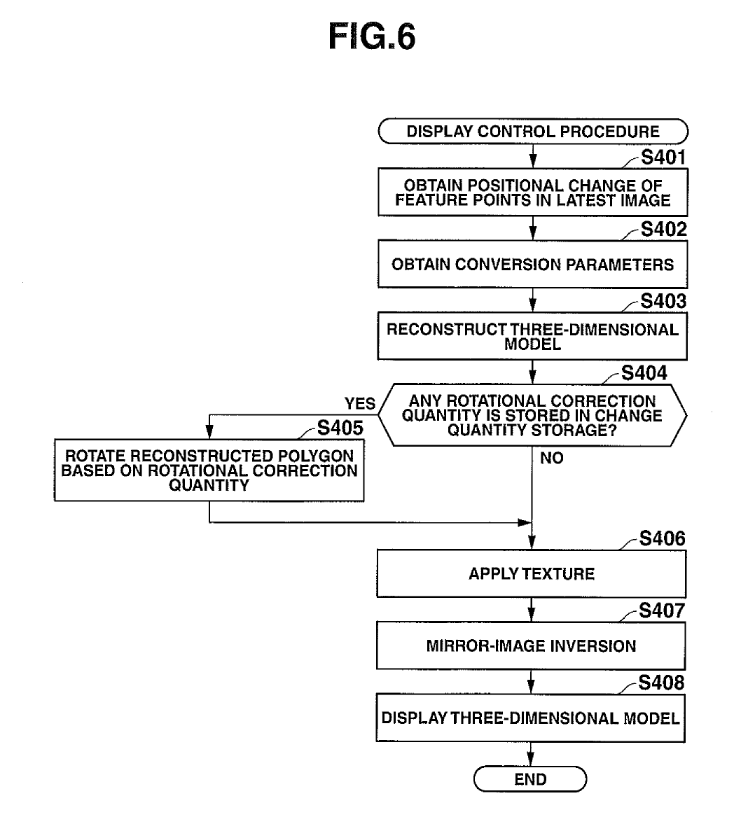

The display control procedure will be described in detail hereafter with reference to FIG. 6. The display control procedure is performed on a frame period basis to display a user image on the display device 10.

As the display procedure starts on a frame period basis, first, the positional change estimate unit 308 obtains the positional change (shift) of the feature points stored in the feature point storage 307 in a latest image stored in the frame image storage 302 (Step S401).

For example, the positional change estimate unit 308 reads the latest image L stored in the frame image storage 302 and extracts from the image L the points corresponding to the feature points stored in the feature point storage 307 using a template matching technique. Then, any change of the feature points is obtained based on the positional relationship between the feature points and corresponding points.

Then, the positional change estimate unit 308 obtains conversion parameters for converting the three-dimensional model stored in the three-dimensional model storage 305 to a three-dimensional model corresponding to the latest image stored in the frame image storage 302 based on the obtained change of the feature points (Step S402).

More specifically, the above procedure is a procedure to obtain a rotation matrix R and transition vector t satisfying the equation (1) below in which X′ is the coordinates of the three-dimensional model stored in the three-dimensional model storage 305 and X is the coordinates of a three-dimensional model corresponding to the latest image stored in the frame image storage 302.

X=RX′+t (1)

Here, the conversion parameters can be calculated, for example, using an epipolar geometry technique. For example, first, a fundamental matrix F is obtained from the positional relationship of the feature points (the positional relationship between the feature points and the corresponding points in the latest image) obtained in the Step S401. Then, an elementary matrix E is obtained from the fundamental matrix F and internal parameters of the camera 20L. Then, the elementary matrix E is split and presented as the product of a skew-symmetric matrix and an orthogonal matrix to obtain a rotation matrix R and transition vector t in the equation (1).

Then, the reconstruction unit 311 converts the coordinates using the obtained conversion parameters to reconstruct the three-dimensional model stored in the three-dimensional model (Step S403). This procedure leads to creating a three-dimensional model corresponding to the latest image.

Then, the reconstruction unit 311 determines whether any rotational correction quantity is stored in the change quantity storage 310 (Step S404).

If no rotational correction quantity is stored (Step S404; No), the reconstruction unit 311 proceeds to Step S406.

If any rotational correction quantity is stored (Step S404; Yes), the reconstruction unit 311 rotates the reconstructed three-dimension model based on the rotational correction quantity (Step S405). In other words, a three-dimensional model oriented as instructed by the user is created. Then, the reconstruction unit 311 deletes information indicating the rotational correction quantity stored in the change quantity storage 310.

Then, in Step S406, the rendering unit 312 creates a three-dimensional model by applying the latest image L stored in the frame image storage 302 as texture to the three-dimensional model that is (1) reconstructed or (2) reconstructed and rotated (Step S406).

Then, the image inversion unit 313 minor-inverts (horizontally flips) the created three-dimensional model using a known technique (Step S407). This procedure is necessary for displaying a user image on the display device 10 like in a minor. On the other hand, this procedure is not always necessary.

Then, the image output unit 314 outputs to the display device 10 two-dimensional projection image data of the created three-dimensional model so as to display the image on the display device 10 (Step S408). Then, the display control procedure ends.

As described above, in the display control procedure, a three-dimensional user image corresponding to a latest image is reconstructed and displayed on a frame period basis.

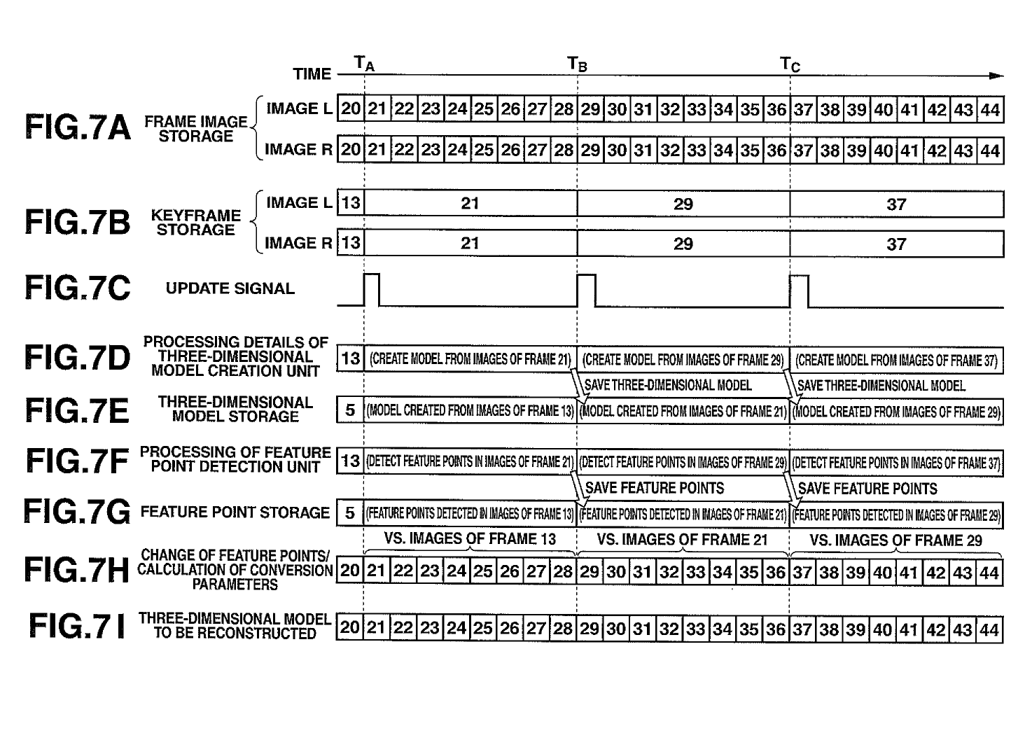

Operation performed in the image processing apparatus 30 will be described hereafter with reference to FIGS. 7A to 7I. FIGS. 7A to 7I are charts showing chronological change in processing details and data in the image processing apparatus 30.

FIG. 7A shows chronological change in the latest pair of images stored in the frame image storage 302. The width of each square of FIG. 7A corresponds to a frame period. The numbers in squares are the frame numbers of the latest images stored in the frame image storage 302.

FIG. 7B shows chronological change in the pair of images stored in the keyframe storage 303. The numbers in FIG. 7B are the frame numbers of the pairs of images stored in the keyframe storage 303.

FIG. 7C shows times when update signals are generated.

FIG. 7D shows chronological change in processing details performed by the three-dimensional modeling unit 304.

FIG. 7E shows chronological change in the three-dimensional model stored in the three-dimensional model storage 305.

FIG. 7F shows chronological change in processing details performed by the feature point detection unit 306.

FIG. 7G shows chronological change in feature points stored in the feature point storage 307.

FIG. 7H is a chart showing change in the frame image used by the positional change estimate unit 308 to detect change of feature points and calculate conversion parameters.

FIG. 7I is a chart showing change in the frame image to which the three-dimensional model to be reconstructed corresponds.

The image acquisition unit 301 sequentially stores in the frame image storage 302 pairs of images simultaneously captured by the cameras 20L and 20R on a frame period basis. Therefore, the latest pair of images stored in the frame image storage 302 is updated on a frame period basis as shown in FIG. 7A.

Furthermore, apart from the above procedure, the image acquisition unit 301 saves the captured pair of images in the keyframe storage 303 in an overwrite fashion on the basis of a predetermined number of frame periods. Here, a pair of images is saved in the keyframe storage 303 in an overwrite fashion in every eight frame periods. In other words, the pair of images stored in the keyframe storage 303 is periodically updated at times as shown in FIG. 7B. Furthermore, as shown in FIG. 7C, the image acquisition unit 301 sends an update signal to the feature point detection unit 306 and the three-dimensional modeling unit 304 when the pair of images stored in the keyframe storage 303 is updated.

In response to reception of the update signal, as shown in FIGS. 7D and 7E, the three-dimensional modeling unit 304 performs the above-described modeling procedure to create a three-dimensional model from the pair of images stored in the keyframe storage 303. Here, generally, it takes several frame periods of time to create a three-dimensional model. Then, the three-dimensional modeling unit 304 stores the created three-dimensional model in the three-dimensional model storage 305 at the time of reception of the next update signal.

More specifically, the three-dimensional modeling unit 304 creates a three-dimensional model from the pair of images of the frame 21 stored in the keyframe storage 303 at a time T_{A} when an update signal is received. Then, the three-dimensional modeling unit 304 saves the created three-dimensional model in the three-dimensional model storage 305 in an overwrite fashion at a time T_{B} when the next update signal is received. Similarly, the three-dimensional modeling unit 304 creates a three-dimensional model from the pair of images of the frame 29 stored in the keyframe image storage 302 at a time T_{B} when an update signal is received and then saves it in the three-dimensional model storage 305 at a time T_{C} when the next update signal is received. Consequently, the three-dimensional model created from the pair of images stored in the keyframe storage 303 is saved in the three-dimensional model storage 305 in an overwrite fashion in every eight frame periods.

Apart from the modeling procedure, the three-dimensional modeling unit 304 performs the following procedure. In response to reception of an update signal, as shown in FIGS. 7F and 7G, the three-dimensional modeling unit 304 performs the above-described feature point detection procedure to detect feature points in the image L stored in the keyframe storage 303. Here, generally, it takes several frame periods of time to detect feature points. Then, the three-dimensional modeling unit 304 saves information regarding the detected feature points in the feature point storage 307 at the time of reception of the next update signal.

More specifically, the feature point detection unit 306 detects feature points in the image L of the frame 21 stored in the keyframe storage 303 at a time T_{A} when an update signal is received. Then, the feature point detection unit 306 saves information regarding the detected feature points in the feature point storage 307 in an overwrite fashion at a time T_{B} when the next update signal is received. Similarly, the feature point detection unit 306 detects feature points in the image L of the frame 29 stored in the keyframe storage 303 at a time T_{B} when an update signal is received and then saves information regarding the detected feature points in the feature point storage 307 in an overwrite fashion at a time T_{C} when the next update signal is received. Consequently, the feature points detected in an image stored in the keyframe storage 303 are saved in the feature point storage 307 in an overwrite fashion in every eight frame periods.

In parallel to the above procedures, the above-described display control procedure is performed on a frame period basis. As shown in FIG. 7H, in the display control procedure, positional change of the feature points detected in the images stored in the keyframe storage 303 in a latest image stored in the frame image storage 302 is calculated. Then, conversion parameters for reconstructing the three-dimensional model are obtained from the calculated positional change of the feature points. Then, as shown in FIG. 7I, a three-dimensional model corresponding to the latest image is reconstructed based on the conversion parameters on a frame period basis.

As described above, the image processing apparatus 30 according to an embodiment of the present invention reconstructs a three-dimensional model created in a period longer than a frame period so as to create a three-dimensional model corresponding to a latest image. Therefore, a three-dimensional model can be created in a short time.

Furthermore, the created three-dimensional model is the one created from a pair of images slightly older than the latest images. However a latest image is applied as texture. Therefore, the motion of the subject is followed in real time without any awkwardness and a minor-like display is realized.

The image processing apparatus 30 according to an embodiment of the present invention reads some change in the user face (opening/closing of the eyes and the eye direction) and changes the orientation of the display. It can usefully be used as a mirror for makeup and other purposes.

In the orientation change procedure of the above embodiment, the rotational correction quantity is updated based on the detected eye state. However, for example, it is possible to analyze images to detect a give motion (gesture) of the user in the images and update the rotational correction quantity based on the detection results. More specifically, it is possible to analyze images stored in the frame image storage 302 to detect a hand motion of the user and update the rotational correction quantity based on the detected hand motion.

It is also possible to conduct a predetermined operation through a not-shown remote control device (remote controller) giving instructions to the image processing apparatus 30 or a not-shown input device such as a keyboard connected to the image processing apparatus 30, and determine and update the rotational correction quantity according to the operation. Furthermore, it is also possible to provide the display device 10 with a touch panel screen, display icons for setting a rotational correction quantity (for example, a right rotation icon and a left rotation icon) in a predetermined region of the screen, and let the user touch the icons to set a rotational correction quantity.

Furthermore, it is possible in the display control procedure to create images of the user seen in different directions or enlarged partial images from a three-dimensional model, and send them to the display device 10 as a one-screen composite image for display. In this way, the user's face is displayed at different angles or at different scales, which is useful for makeup and other purposes.

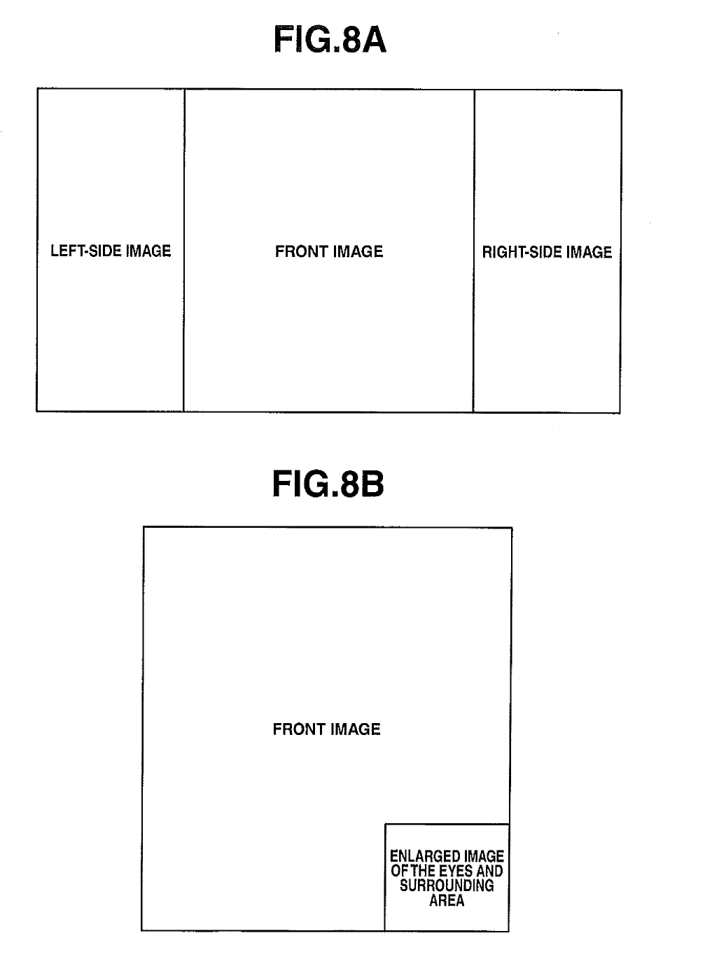

More specifically, in the display control procedure, the three dimensional model is reconstructed to create a front image of the user, a right image showing the user seen from right, and a left image showing the user seen from left, and combine these images on one screen for display on the display device 10 as shown in FIG. 8A.

Alternatively, as shown in FIG. 8B, a front image of the user and an enlarged image of the user's eyes and surrounding area can be combined on one screen for display.

Furthermore, the number of cameras 20 is not restricted to two. The present invention is applicable to a system creating a three-dimensional model from images captured by any larger number of cameras 20.

Furthermore, for example, it is possible to apply the operation programs defining the operation of the image processing apparatus 30 according to the present invention to an existing personal computer or information terminal device so that the personal computer or the like serves as the image processing apparatus 30 according to the present invention.

The above programs can be distributed by any method. For example, the programs can be stored and distribute on a computer-readable recording medium such as a CD-ROM (compact disk read-only memory), DVD (digital versatile disk), MO (magneto-optical disk), and memory card. Alternatively, the programs can be distributed via a communication network such as the Internet.

A preferable embodiment of the present invention is described in detail above. The present invention is not confined to this particular embodiment and various modifications and changes can be made without departing from the scope of the invention described in the scope of claims.

Having described and illustrated the principles of this application by reference to one preferred embodiment, it should be apparent that the preferred embodiment may be modified in arrangement and detail without departing from the principles disclosed herein and that it is intended that the application be construed as including all such modifications and variations insofar as they come within the spirit and scope of the subject matter disclosed herein.

What is claimed is:

1. An image processing apparatus, comprising:
an image acquirer which successively acquires sets of images of a subject captured at different positions;
a three-dimensional model creator which creates a three-dimensional model of the subject from one set of images selected among the sets of images successively acquired by the image acquirer;
a feature point detector which detects feature points in the one set of images;
a positional change acquirer which acquires positional change of the feature points detected by the feature point detector in a latest image acquired by the image acquirer;
a conversion parameter calculator which calculates conversion parameters for converting the three-dimensional model created by the three-dimensional model creator to a three-dimensional model corresponding to the latest image based on the positional change of the feature points acquired by the positional change acquirer;
a reconstructor which reconstructs the three-dimensional model created by the three-dimensional model creator based on the conversion parameters;
a render which creates a three-dimensional model in which an image of the subject in the latest image is applied as texture to the three-dimensional model reconstructed by the reconstructor; and
a display controller which causes a display device to display the three-dimensional model created by the render.

2. The image processing apparatus according to claim 1, wherein:
the image acquirer successively acquires the sets of images of the subject captured at different positions with a predetermined periodicity; and
the three-dimensional model creator creates the three-dimensional model of the subject from one set of images selected intermittently among the sets of images successively acquired by the image acquirer.

3. The image processing apparatus according to claim 1, further comprising:
a display orientation acquirer acquiring a rotational correction quantity indicating a quantity to change a display orientation of the three-dimensional model,
wherein the reconstructor reconstructs the three-dimensional model created by the three-dimensional model creator based on the conversion parameters and the rotational correction quantity.

4. The image processing apparatus according to claim 3, wherein:
the display orientation acquirer (i) detects change in a state of the subject displayed in the images acquired by the image acquirer and (ii) acquires the rotational correction quantity based on the detected change in a state of the subject.

5. The image processing apparatus according to claim 4, wherein:
the display orientation acquirer (i) detects information indicating an opening/closing state of eyes and eyeball motion of the subject displayed in the images acquired by the image acquirer and (ii) acquires the rotational correction quantity based on the detected information.

6. The image processing apparatus according to claim 1, wherein:
the display controller causes the display device to display a three-dimensional model flipped horizontally from the three-dimensional model created by the render.

7. An image processing method for an image processing apparatus displaying a three-dimensional model on a display device, comprising:
successively acquiring sets of images of a subject captured at different positions;
creating a three-dimensional model of the subject from one set of images selected among the sets of images successively acquired;
detecting feature points in the one set of images;
acquiring positional change of the detected feature points in a latest image among the sets of images successively acquired;
calculating conversion parameters for converting the created three-dimensional model to a three-dimensional model corresponding to the latest image based on the acquired positional change of the feature points;
reconstructing the created three-dimensional model based on the calculated conversion parameters;
creating a three-dimensional model in which an image of the subject in the latest image is applied as texture to the reconstructed three-dimensional model; and
displaying the created three-dimensional model on the display device.

8. A non-transitory computer-readable recording medium having stored therein a program executable by a computer that controls an image processing apparatus displaying a three-dimensional model on a display device, causing the computer to realize functions of:
successively acquiring sets of images of a subject captured at different positions;
creating a three-dimensional model of the subject from one set of images selected among the sets of images successively acquired;
detecting feature points in the one set of images;
acquiring positional change of the detected feature points in a latest image among the sets of images successively acquired;
calculating conversion parameters for converting the created three-dimensional model to a three-dimensional model corresponding to the latest image based on the acquired positional change of the feature points;
reconstructing the created three-dimensional model based on the calculated conversion parameters;
creating a three-dimensional model in which an image of the subject in the latest image is applied as texture to the reconstructed three-dimensional model; and
displaying the created three-dimensional model on the display device.
